(19) United States
(12) Patent Application Publication
(10) Pub. No.: US 2011/0213638 A1
(43) Pub. Date: Sep. 1, 2011

(54) CONTENT DISTRIBUTION SYSTEM, CONTENT DISTRIBUTION SERVER, AND CONTENT DISTRIBUTION PROGRAM

(76) Inventor: Shigehisa Omatsu, Chiba (JP)

(21) Appl. No.: 13/126,711

(22) PCT Filed: Aug. 16, 2010
(86) PCT No.: PCT/JP2010/005065

§ 371 Date: Apr. 28, 2011

(30) Foreign Application Priority Data
Aug. 31, 2009 (JP) 2009-201115

(51) Int. Cl. G06Q 10/00; G06Q 30/00

(52) U.S. Cl. 705/7.29; 705/14.55; 705/14.72

(57) ABSTRACT

A content delivery server includes: a content DB for storing content information containing the content; and a goods sales history DB for storing goods sales history information indicating sales history of the goods. In the case where a content view request specifying the content is received, the content delivery server creates goods related information relating to the goods that appear in the specified content using the goods sales history information; creates a content view screen including the created goods related information and the content specified by the content view request; and transmits the created content view screen to a user terminal that carries out the content view request.

### CROSS REFERENCE TO RELATED APPLICATIONS

The present application is a PCT national stage of PCT Application No. PCT/JP2010/005065, filed on Aug. 16, 2010, and claims priority to and incorporates by reference Japanese patent Application No. 2009-201115 filed on Aug. 31, 2009.

### BACKGROUND

Exemplary embodiments of the present invention relates to a content delivery system provided with a content delivery server, the content delivery server, and a content delivery program, which deliver content to a user terminal in the case where a content view request is received from the user terminal via a communication network.

Heretofore, there have been provided various systems that deliver advertising information for advertisement of goods to user terminals managed by consumers or the like via a communication network (see Japanese Patent Application Publication No. 2003-296357, for example).

It is thought that, when to deliver content such as advertising information, evaluation of goods for an advertising target and the like are added thereto. However, there has been a problem that it is impossible to add highly reliable and objective information relating to the goods into the advertising information and to deliver it in the case where the advertising information is created by a general consumer who is not a manufacturer or vendor of the goods, evaluation of the goods is not carried out effectively.

In the case where advertising information is created by a general consumer or the like in particular, reliability of advertising content indicated by the advertising information becomes lower. Thus, it is desired that reliable and objective information relating to goods of the advertising target is added thereto.

### SUMMARY

The present invention solves the problem described above, and it is an object of exemplary embodiments of the present invention to allow highly reliable and objective information relating to goods to be effectively added into content created by an arbitrary person or the like, such as advertising information, and to allow the content into which the highly reliable and objective information is added to be delivered.

A content delivery system according to an exemplary embodiment of the present invention is characterized by including a user terminal and a content delivery server, the content delivery server delivering content to the user terminal in the case where a content view request is received from the user terminal via a communication network, wherein the content delivery server includes: content information storing means for storing content information containing content; goods sales history information storing means for storing goods sales history information indicating a sales history of goods; goods related information creating means for creating goods related information using the goods sales history information in the case where a content view request specifying the content is received, the goods related information relating to the goods that appear in the specified content; content view information creating means for creating content view information, the content view information containing the goods related information created by the goods related information creating means and the content specified by the content view request; and content view information transmitting means for transmitting the content view information created by the content view information creating means to the user terminal that carries out the content view request.

By configuring it as described above, it is possible to effectively add highly reliable and objective information relating to goods into content created by an arbitrary person or the like, and to deliver the content into which the highly reliable and objective information is added.

It may be configured so that the content view information creating means creates a content view screen, in which the content view screen includes a display region for the goods related information and a display region for the content, as the content view information.

It may be configured so that the content delivery server includes: goods information storing means for storing goods information, the goods information containing goods introduction information used for introduction of the goods; and goods introduction information extracting means for extracting goods introduction information on the goods by referring to the goods information in the case where the content view request specifying the content is received, the goods appearing in the specified content, wherein the content view information creating means creates the content view information containing the goods introduction information extracted by the goods introduction information extracting means.

It may be configured so that the content delivery server includes: goods sales history information receiving means for receiving the goods sales history information indicating the sales history of the goods in a retail store from a store terminal managed by the retail store, the retail store carrying out sales of the goods; and goods sales history information registering means for registering the goods sales history information received by the goods sales history information receiving means in the goods sales history information storing means.

It may be configured so that the goods sales history information stored in the goods sales history information storing means is information in which a trade name of the sold goods, a goods category to which the sold goods belong, and sales quantity are associated with each other, and that the goods related information creating means analyzes the goods sales history information, and creates a sales quantity ranking of the goods in the goods category to which the goods appearing in the content specified by the content view request belong as the goods related information.

It may be configured so that the goods sales history information stored in the goods sales history information storing means is information in which a trade name of the sold goods, a goods category to which the sold goods belong, and a sales price are associated with each other, and that the goods related information creating means analyzes the goods sales history information, and creates a sales price ranking of the goods in the goods category to which the goods appearing in the content specified by the content view request belong as the goods related information.

The content contained in the content information is an animated image or still image aimed at introduction of the goods, for example.

Further, a content delivery server according to an exemplary embodiment of the present invention is a content delivery server for delivering content to a user terminal in the case where a content view request is received from the user terminal via a communication network, the content delivery server including: content information storing means for storing content information containing content; goods sales history information storing means for storing goods sales history information indicating a sales history of goods; goods related information creating means for creating goods related information using the goods sales history information in the case where a content view request specifying the content is received, the goods related information relating to the goods that appear in the specified content; content view information creating means for creating content view information, the content view information containing the goods related information created by the goods related information creating means and the content specified by the content view request; and content view information transmitting means for transmitting the content view information created by the content view information creating means to the user terminal that carries out the content view request.

Moreover, a content delivery program according to an exemplary embodiment of the present invention is a content delivery program for delivering content to a user terminal in the case where a content view request is received from the user terminal via a communication network, the content delivery program causing a computer to execute: content information storing means for storing content information containing content; a goods related information creating process to create goods related information using goods sales history information stored in goods sales history information storing means for storing the goods sales history information in the case where a content view request specifying the content is received, the goods related information relating to goods that appear in the specified content, the goods sales history information indicating sales history of the goods; a content view information creating process to create content view information, the content view information containing the goods related information created in the goods related information creating process and the content specified by the content view request; and a content view information transmitting process to transmit the content view information created in the content view information creating process to the user terminal that carries out the content view request.

According to the present invention, it becomes possible to effectively add highly reliable and objective information relating to goods into content such as advertising information created by an arbitrary person or the like, and it further becomes possible to provide the content into which the highly reliable and objective information is added.

### BRIEF DESCRIPTION OF THE DRAWINGS

FIG. 1 is a block diagram showing an example of a configuration of a content delivery system according to one embodiment of the present invention.

FIG. 2 is an explanatory drawing showing an example of content information.

FIG. 3 is an explanatory drawing showing an example of goods information.

FIG. 4 is an explanatory drawing showing an example of goods sales history information.

FIG. 5 is a flowchart showing an example of a content information registering process.

FIG. 6 is a flowchart showing an example of a content delivery process.

FIG. 7 is an explanatory drawing showing an example of a content selecting screen.

FIG. 8 is an explanatory drawing showing an example of a content view screen.

### DETAILED DESCRIPTION

Hereinafter, one embodiment of the present invention will be described with reference to the drawings.

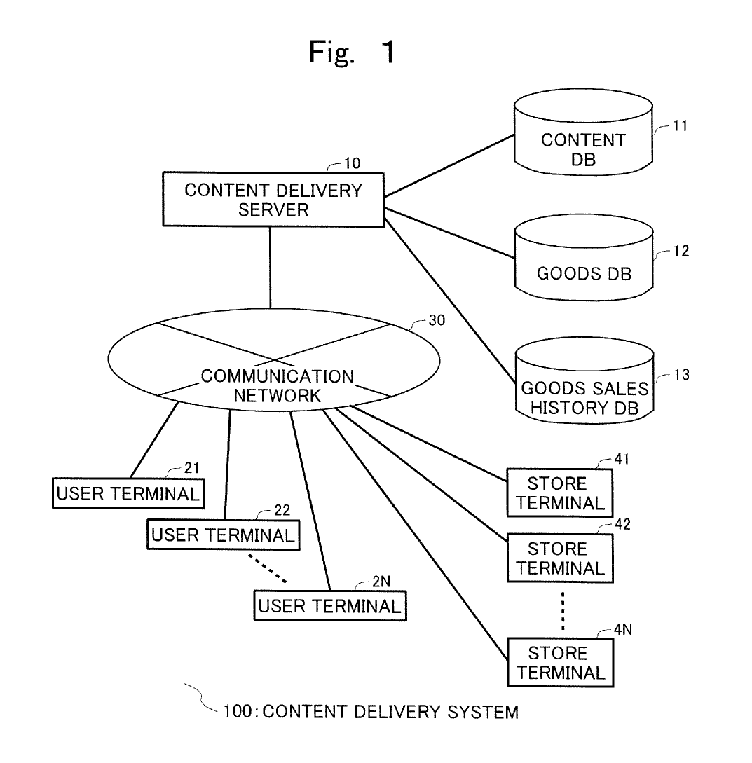

FIG. 1 is a block diagram showing an example of a configuration of a content delivery system 100 according to one embodiment of the present invention. As shown in FIG. 1, the content delivery system 100 includes a content delivery server 10, user terminals 21 to 2N (N: arbitrary positive integer), and store terminals 41 to 4N (N: arbitrary positive integer).

Each of the content delivery server 10, the user terminals 21 to 2N and the store terminals 41 to 4N is connected to a communication network 30 such as the Internet, for example.

The content delivery server 10 is a server managed by a system administrator of the present system 100, for example, and is configured by an information-processing device such as a WWW server. The content delivery server 10 includes: a content DB 11 for storing content information, which contains various kinds of information relating to content; a goods DB 12 for storing goods information, which contains various kinds of information relating to goods; and a goods sales history DB 13 for storing goods sales history information, which contains various kinds of information indicating a sales history of each of the goods. In this regard, each of the content DB 11, the goods DB 12 and the goods sales history DB 13 may be placed inside or outside the content delivery server 10.

Each of the user terminals 21 to 2N is managed by a user of the present system 100, who creates and registers content, or a user of the present system 100, who views the content, for example, and is configured by an information-processing device such as a personal computer or a mobile communication terminal, for example.

Each of the store terminals 41 to 4N is managed by a store manager who manages each store for carrying out sales of goods, and is configured by an information-processing device such as a personal computer or a mobile communication terminal, for example. Each of the store terminals 41 to 4N carries out a process to transmit goods sales history information accumulated in each store to the content delivery server 10 in response to an operation of a predetermined person in charge.

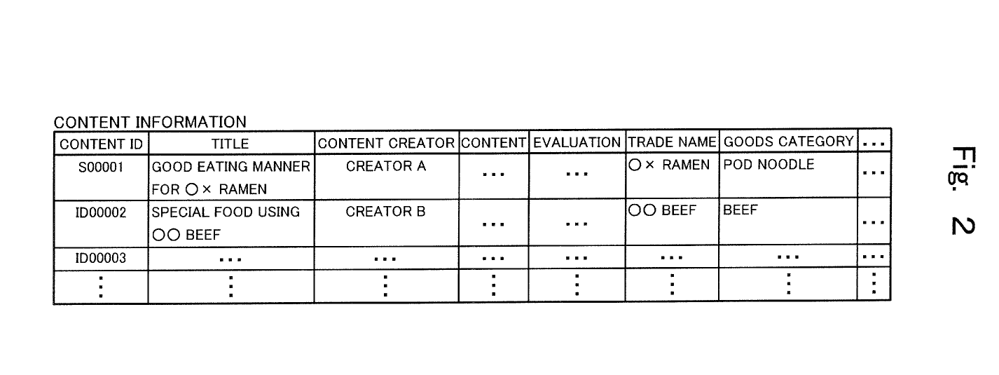

FIG. 2 is an explanatory drawing showing an example of the content information stored in the content DB 11. As shown in FIG. 2, the content information is information containing: a content ID capable of uniquely identifying content; a title of the corresponding content; a creator of the corresponding content; the content; evaluation of the corresponding content by a third party (a name of evaluator and the content of evaluation); a trade name of goods for an advertising target by the content; and a goods category indicating a category to which the goods for the advertising target by the content belong, for example.

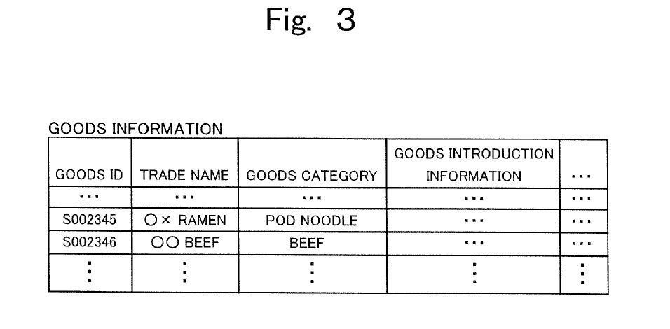

FIG. 3 is an explanatory drawing showing an example of the goods information stored in the goods DB 12. As shown in FIG. 3, the goods information is information containing: a goods ID capable of uniquely identifying goods; a trade name of the corresponding goods; a goods category indicating a category to which the corresponding goods belong; and goods introduction information that is to be used when the corresponding goods are introduced, for example.

The “goods introduction information” is information indicating details of the corresponding goods, such as a raw material name of the corresponding goods, an internal capacity, a method of preserving it, a manufacturer, an address of the manufacturer, a vendor, an address of the vendor, display of nutritional components including display of a calorie of energy, timing of the opening for sales, and a recipe for foods using the corresponding goods, for example.

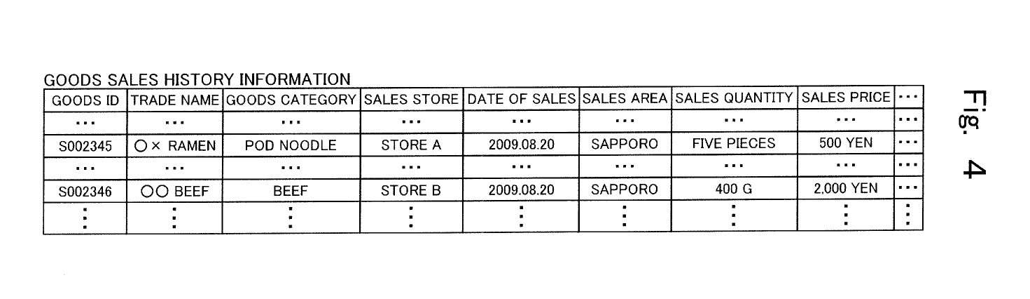

FIG. 4 is an explanatory drawing showing an example of the goods sales history information stored in the goods sales history DB 13. As shown in FIG. 4, the goods sales history information is information containing: a goods ID capable of uniquely identifying goods; a trade name of the corresponding goods; a goods category indicating a category to which the corresponding goods belong; a sales store that sold the corresponding goods; date of sales (which may be date and hour of sales); a sales area indicating an area in which the sales store is positioned; sales quantity; and a sales price, for example.

Next, an operation of the content delivery system 100 according to the present embodiment will be described.

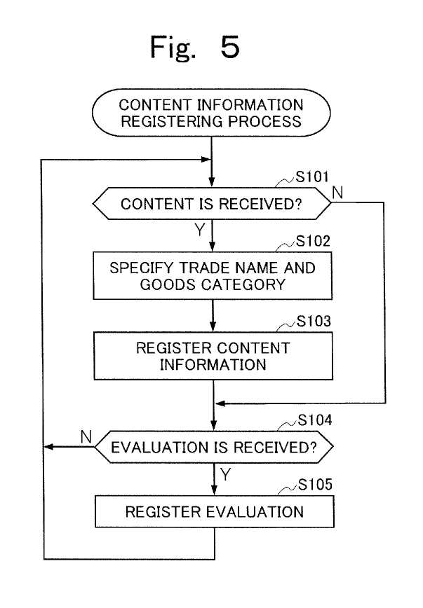

FIG. 5 is a flowchart showing an example of a content information registering process carried out by the content delivery server 10 in the content delivery system 100 according to the present embodiment. Here, the case where content is received from a user terminal 21 managed by a user X to register content information and evaluation is received from a user terminal 22 managed by a user Y to register it will be described as an example. In this regard, an explanation of processes other than the processes particularly relating to the present invention may be omitted.

In the content information registering process, the content delivery server 10 first confirms whether content is received or not (Step S101). In the present embodiment, the user terminal 21 accesses a content registration site offered by the content delivery server 10 in response to an operation of the user X (i.e., the user terminal 21 accesses a URL (Uniform Resource Locator) of the content registration site), and transmits, to the content delivery server 10, content C specified by the user X on a screen of the content registration site (for example, the content created by the user X) and content registration needed information necessary for registration of content inputted by the user X on the screen of the content registration site. At Step S101, the content delivery server 10 confirms whether the content into which the content registration needed information is added is received or not.

The “content registration needed information” is information containing a title of the content and a creator of the content, for example. In this regard, other information such as a trade name of goods that are the advertising target in the content may be contained in the “content registration needed information”. Here, the content C into which the content registration needed information, in which a “good eating manner for ∘×ramen” is set to a title and a “creator A” is set to a content creator indicating the user X, is added is transmitted by the user terminal 21.

When the content C into which the content registration needed information is added is received (“Yes” at Step S101), the content delivery server 10 analyzes the received information to specify the trade name of the goods that are the advertising target in the content C, and specifies a goods category of the goods indicated by the trade name (Step S102). More specifically, for example, a trade name clearly specified in the title contained in the received content registration needed information is specified as the trade name of the goods set as the advertising target. Then, the goods category associated with the specified trade name may be specified by referring to goods category specifying information (information in which a trade name of each of goods is associated with its goods category) stored in a goods category specifying DB (not shown in the drawings). In this regard, in the case where an item of the trade name is included in the content registration needed information, the trade name specified by the item may be specified as the trade name of the goods that are set as the advertising target.

Subsequently, the content delivery server 10 creates content information containing the content C and the content registration needed information, which are received from the user terminal 21, the specified trade name and the goods category; and registers the created content information in the content DB 11 (Step S103). At this Step S103, the content ID is determined; the content information in which the content registration needed information (herein, the title and the content creator), the content C, a trade name and a goods category are associated with the determined content ID (see the content information of the content ID “S00001” in FIG. 2) is created; and it is registered in the content DB 11.

Next, the content delivery server 10 confirms whether evaluation of the content indicated by the registered content information is received or not (Step S104). In the present embodiment, the user terminal 22 accesses a content viewing site offered by the content delivery server 10 in response to an operation of the user Y; and transmits, to the content delivery server 10, evaluation information indicating evaluation about the content inputted after content such as an image or an animated image is viewed on a screen of the content viewing site by the user Y. At Step S104, the content delivery server 10 confirms whether the evaluation information indicating the evaluation of the content specified for the content of the evaluation target is received or not. The evaluation information contains: the content ID capable of identifying the content of the evaluation target; and evaluation as text data for the content.

When the evaluation is received (“Yes” at Step S104), the content delivery server 10 specifies the content information containing the content set as the evaluation target of the received evaluation, and registers the received evaluation as an item of the evaluation in the specified content information (Step S105). At Step S105, the content information is specified by the content ID contained in the evaluation information received at Step S104, and the evaluation contained in the evaluation information received at Step S104 is registered in the item of the evaluation in the specified content information.

As described above, the process to create and register the content information containing the content created by the content creator, and the process to register the evaluation of the content by a viewer of the content are carried out.

Here, a goods sales history information accumulating process carried out by the content delivery server 10 will be described. In the goods sales history information accumulating process, the content delivery server 10 always monitors whether goods sales history information is received from any of the store terminals 41 to 4N or not, for example. In the case where goods sales history information is received, the received goods sales history information is registered in the goods sales history DB 13.

In the present embodiment, each of the store terminals 41 to 4N transmits, to the content delivery server 10, unsent goods sales history information of the goods sales history information indicating a sales history of the goods in the corresponding store in response to an operation of a predetermined person in charge. Transmission timing of the goods sales history information may be any timing such as everyday (for example, after closing) or every time goods are sold.

As described above, a process to collect the goods sales history information created by each store and a process to register it in the goods sales history DB 13 are carried out.

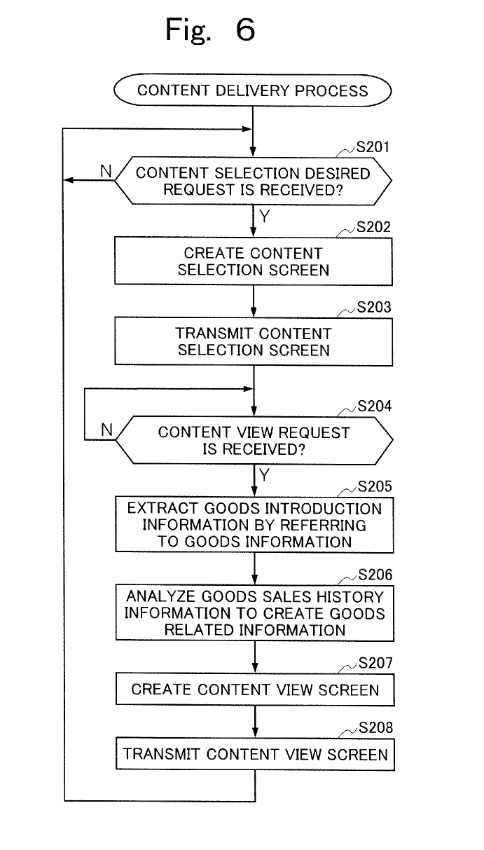

Next, a content delivery process in the content delivery system 100 according to the present embodiment will be described. FIG. 6 is a flowchart showing an example of the content delivery process carried out by the content delivery server 10. Here, the case where the content delivery server 10 delivers content in response to a request from the user terminal 22 managed by the user Y will be described as an example. In this regard, an explanation of processes other than the processes particularly relating to the present invention may be omitted.

In the content delivery process, when the content delivery server 10 first receives a content selection desired request from the user terminal 22 (“Yes” at Step S201), the content delivery server 10 refers to the content DB 11 to create a content selecting screen in which a display region for displaying a title list of the content, in which the content information is registered, is provided; and transmits the created content selecting screen to the user terminal 22 (Step S202).

In the present embodiment, the user terminal 21 accesses a content viewing site opened by the content delivery server 10 in response to an operation of the user Y, by which it carries out a content selection desired request. More specifically, it is accessed using a URL of the content viewing site offered by the administrator of the content delivery server 10.

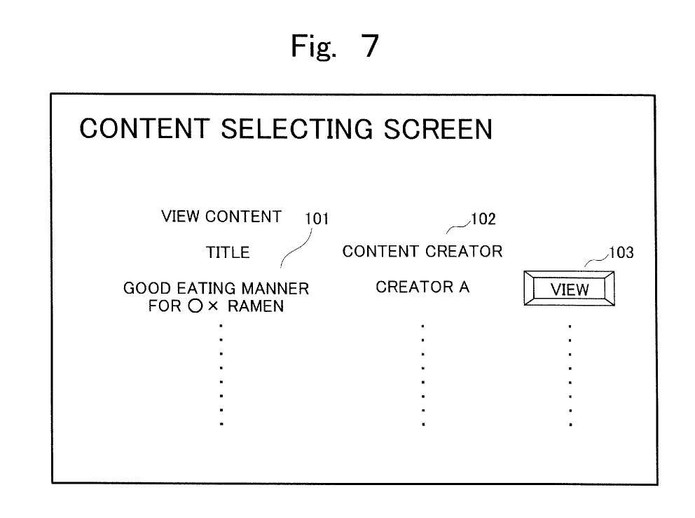

The user terminal 22 causes a display device equipped therein to display the content selecting screen from the content delivery server 10. The content selecting screen is a screen in which a title of viewable content is selectively displayed, and as shown in FIG. 7, for example, a title display region 101 in which the title of the viewable content is displayed, a creator display region 102 in which a creator of the content is displayed, and a view button 103 that is to be pressed when to view the content are provided so as to be associated with each other.

When the content selecting screen is displayed, the user Y confirms a title and a creator of the content, and presses the view button 103 corresponding to the content that he or she wants to view. When press on the view button 103 is received, the user terminal 22 transmits, to the content delivery server 10, a content view request for specifying the content that he or she wants to view (for example, the content ID is associated with the view button, and it is specified by the content ID).

When the content delivery server 10 receives the content view request from the user terminal 22 (“Yes” at Step S204), the content delivery server 10 refers to goods information stored in the goods DB 12, and extracts goods introduction information on the goods that become an advertising target in the content for which the view request is received (Step S205).

At Step S205, a process in which a trade name of the goods, which is associated with the content ID included in the content view request, is specified by referring to the content information, and a process in which the goods introduction information, which is contained in the goods information on the goods with the specified trade name, is extracted by referring to the goods information are carried out.

Next, the content delivery server 10 analyzes the goods sales history information accumulated in the goods sales history DB 13, and creates goods related information on the goods associated with the content ID contained in the content view request (Step S206).

In the present embodiment, at Step S206, the content delivery server 10 specifies the goods category of the goods (i.e., goods associated with the content ID contained in the content view request), which are set as the advertising target in the content requested to view, by referring to the content information; extracts the goods sales history information on the goods of the specified goods category by referring to the goods sales history DB 13; calculates a sales price of each of the goods belonging to the respective goods categories by analyzing the extracted goods sales history information; and creates a sales ranking, in which the goods are put in descending order of sales prices, as the goods related information.

In the present embodiment, using the goods sales history information in which dates of sales are within a predetermined period of time (for example, for the last three months, for the last two months, for the last two months from the end of the last month, or the like), a sales ranking within the predetermined period of time is created. In this regard, the goods related information may be created for the entire period of time.

Further, in the present embodiment, the content delivery server 10 in advance stores behavior areas (for example, an area in which his or her house exists, an area in which his or her workplace exists, or the like) of each of the users who respectively manage the user terminals 21 to 2N in a user DB (not shown in the drawings) equipped therein as user information; and creates a sales ranking in a sales area using the goods sales history information in which the sales area becomes a behavior area of the user who carries out the content view request. In this case, information capable of identifying the corresponding user or user terminal is contained in the content view request, and the behavior area may be specified by referring to the user information using the information capable of identifying the corresponding user or user terminal. In this regard, the goods related information may be created for the whole area.

In this regard, in the present embodiment, the content delivery server 10 may acquire current position information of the user terminal 21 to 2N that transmits the content view request from the user terminal 21 to 2N, and create the sales ranking in the sales area using the goods sales history information in which a sales area is an area in which a current position of the user terminal that transmits the content view request exists. In this case, each of the user terminals 21 to 2N may have a function to measure its own current position by means of a GPS (Global Positioning System) or the like, for example, and transmit a content view request including the current position information.

Next, the content delivery server 10 creates a content view screen including a display region of the goods introduction information extracted at Step S205, a display region of the goods related information created at Step S206 and a display region for displaying evaluation of the corresponding goods (Step S207), and transmits the created content view screen to the user terminal 22 (Step S208).

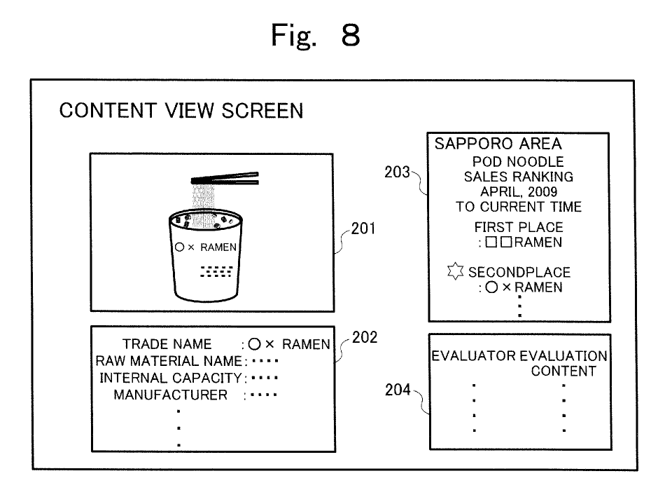

The user terminal 22 causes the display device equipped therein to display the content view screen from the content delivery server 10. In the content view screen, as shown in FIG. 8, a content display region 201 for displaying the content, a goods introduction information display region 202 for displaying the goods introduction information, a goods related information display region 203 for displaying the goods related information, and an evaluation display region 204 for displaying the evaluation of the corresponding goods are provided, for example.

In the present embodiment, content such as an animated image or a still image requested to view the content is displayed in the content display region 201. Further, the goods introduction information such as a trade name of the corresponding goods, a raw material name, an internal capacity, a manufacturer and a recipe is displayed in the goods introduction information display region 202. The goods related information such as a sales ranking in the respective goods in a goods category to which the corresponding goods belong is displayed in the goods related information display region 203. Moreover, evaluation content of the corresponding goods from each user and an evaluator who is a user carrying out the evaluation is displayed in the evaluation display region 204.

By causing the content view screen to be displayed, the user Y is allowed to: view the goods introduction information of the goods set as the advertising target in the content; view the goods related information such as the sales ranking of the respective goods belonging to the goods category, to which the goods set as the advertising target in the content belong, in its own behavior area for a predetermined period of time; and view the evaluation of the goods set as the advertising target in the content by a third party, while viewing the desired content. By viewing the goods introduction information, it is possible to obtain not only low reliable information such as the evaluation by a third party but also objective and highly reliable information such as sales or rating of the corresponding goods.

In this regard, in the embodiment described above, it has been configured so as to create a sales ranking about a sales price of each of goods in the goods category to which the corresponding goods belong as the goods related information. However, it may be any information so long as it is information relating to the corresponding goods that can be created using the goods sales history information collected from each of the store terminals 41 to 4N. For example, a ranking of sales quantity of each of the goods, a sales ranking of the corresponding goods in each sales area, a sales ranking of the corresponding goods for each week, sales of the corresponding goods in each sales area, sales of the corresponding goods for each week, sales of the corresponding goods in each retail store and the like may be created as the goods related information.

Further, the content for carrying out introduction (advertisement) of the goods by means of an animated image, a still image or the like has been explained as an example in the embodiment described above. However, it may be any content that is not aimed at introduction (advertisement), so long as it is one on which the goods appears.

As explained above, in the one embodiment described above, the content delivery server 10 that delivers content to the user terminal 22 in the case where a content view request is received from the user terminal 22 via the communication network 30 includes the content DB 11 for storing the content information containing the content and the goods sales history DB 13 for storing the goods sales history information indicating sales history of the goods; creates the goods related information relating to the goods that appear in the specified content using the goods sales history information in the case where the content view request specifying the content is received; creates the content view information (for example, the content view screen) containing the created goods related information and the content specified by the content view request; and transmits the created content view information to the user terminal 22 that carries out the content view request. Therefore, it is possible to effectively add highly reliable and objective information relating to the goods into the content such as advertising information created by an arbitrary person or the like, and to deliver the content into which the highly reliable and objective information is added.

Namely, it is configured so that the content view information containing the content and the goods related information created using the goods sales history information relating to the goods that appear in the content is delivered. Therefore, it becomes possible to provide the content together with the goods related information that is the highly reliable and objective information created on the basis of actual sales history, and it is possible for a person who views the content to obtain certain information based on the sales history of the goods that appear in the content.

Further, in the embodiment described above, the content delivery server 10 is configured so as to create the content view screen, in which the content view screen includes the display region for the goods related information and the display region for the content, as the content view information. Therefore, it is possible to provide a screen on which the content and the goods related information can be viewed at the same time.

Further, in the embodiment described above, the content delivery server 10 is configured so as to include the goods DB 12 for storing the goods information, the goods information containing goods introduction information used for introduction of the goods; extracts the goods introduction information on the goods that appear in the specified content by referring to the goods information in the case where the content view request specifying the content is received; and creates the content view information containing the extracted goods introduction information. Therefore, it becomes possible to provide the content together with the goods introduction information, and it is possible for a person who views the content to obtain information on details of the goods that appear in the content.

Further, in the embodiment described above, the content delivery server 10 is configured so as to receive the goods sales history information indicating the sales history of the goods in the retail store from each of the store terminals 41 to 4N managed by the retail store that carries out sales of the goods, and register the received goods sales history information in the goods sales history DB 13. Therefore, it is possible to easily collect and accumulate the goods sales history information indicating the sales history of the goods in each store, and it becomes possible to create the goods related information using the goods sales history information collected from each store.

Further, in the embodiment described above, in the case where the goods sales history information stored in the goods sales history DB 13 is information in which the trade name of the sold goods, the goods category to which the sold goods belong, and the sales quantity are associated with each other and the content delivery server 10 is configured so as to analyze the goods sales history information and to create the sales quantity ranking of the respective goods in the goods category to which the goods appearing in the content specified by the content view request belong as the goods related information, it is possible to add the sales quantity ranking of the respective goods in the goods category, to which the goods appearing in the content such as the advertising information created by an arbitrary person or the like belong, into the content, and it is possible to provide the content into which the sales quantity ranking is added as the highly reliable and objective information.

Further, in the embodiment described above, in the case where the goods sales history information stored in the goods sales history DB 13 is information in which the trade name of the sold goods, the goods category to which the sold goods belong, and the sales price are associated with each other and the content delivery server 10 is configured so as to analyze the goods sales history information and to create the sales price ranking of the respective goods in the goods category to which the goods appearing the content specified by the content view request belong as the goods related information, it is possible to add the sales price ranking of the respective goods in the goods category, to which the goods appearing in the content such as the advertising information created by an arbitrary person or the like belong, into the content, and it is possible to provide the content into which the sales price ranking is added as the highly reliable and objective information.

In this regard, although it has not been described particularly in the embodiment described above, the content delivery server 10 constituting the content delivery system 100 carries out various kinds of processes described above (see FIG. 5 and FIG. 6) in accordance with a processing program (content delivery program) stored in a storage medium equipped therein.

According to the present invention, it is useful to effectively add highly reliable and objective information relating to goods into content such as advertising information created by an arbitrary person or the like, and to provide the content into which the highly reliable and objective information is added.

1. A content delivery system comprising a user terminal and a content delivery server, the content delivery server delivering content to the user terminal in the case where a content view request is received from the user terminal via a communication network,
wherein the content delivery server comprises:
content information memory for storing content information containing content;
goods sales history information memory for storing goods sales history information indicating a sales history of goods;
goods related information creating section for creating goods related information using the goods sales history information in the case where a content view request specifying the content is received, the goods related information relating to the goods that appear in the specified content;
content view information creating section for creating content view information, the content view information containing the goods related information created by the goods related information creating section and the content specified by the content view request; and
content view information transmitting section for transmitting the content view information created by the content view information creating section to the user terminal that carries out the content view request.

2. The content delivery system according to claim 1, wherein the content view information creating section creates a content view screen as the content view information in which the content view screen includes a display region for the goods related information and a display region for the content.

3. The content delivery system according to claim 1, wherein the content delivery server further comprises:
goods information memory for storing goods information, the goods information containing goods introduction information used for introduction of the goods; and
goods introduction information extracting section for extracting goods introduction information on the goods by referring to the goods information in the case where the content view request specifying the content is received, the goods appearing in the specified content,
wherein the content view information creating section creates the content view information containing the goods introduction information extracted by the goods introduction information extracting section.

4. The content delivery system according to claim 1, wherein the content delivery server further comprises:
goods sales history information receiving section for receiving the goods sales history information indicating the sales history of the goods in a retail store from a store terminal managed by the retail store, the retail store carrying out sales of goods; and
goods sales history information registering section for registering the goods sales history information received by the goods sales history information receiving section in the goods sales history information memory.

5. The content delivery system according to claim 1, wherein the goods sales history information stored in the goods sales history information memory is information in which a trade name of the sold goods, a goods category to which the sold goods belong, and sales quantity are associated with each other, and
wherein the goods related information creating section analyzes the goods sales history information, and creates a sales quantity ranking of the goods in the goods category to which the goods appearing in the content specified by the content view request belong as the goods related information.

6. The content delivery system according to claim 1, wherein the goods sales history information stored in the goods sales history information memory is information in which a trade name of the sold goods, a goods category to which the sold goods belong, and a sales price are associated with each other, and
wherein the goods related information creating section analyzes the goods sales history information, and creates a sales price ranking of the goods in the goods category to which the goods appearing in the content specified by the content view request belong as the goods related information.

7. The content delivery system according to claim 1, wherein the content contained in the content information is an animated image or still image aimed at introduction of the goods.

8. A content delivery server for delivering content to a user terminal in the case where a content view request is received from the user terminal via a communication network, the content delivery server comprising:
content information memory for storing content information containing content;
goods sales history information memory for storing goods sales history information indicating a sales history of goods;
goods related information creating section for creating goods related information using the goods sales history information in the case where a content view request specifying the content is received, the goods related information relating to the goods that appear in the specified content;
content view information creating section for creating content view information, the content view information containing the goods related information created by the goods related information creating section and the content specified by the content view request; and
content view information transmitting section for transmitting the content view information created by the content view information creating section to the user terminal that carries out the content view request.

9. A content delivery program for delivering content to a user terminal in the case where a content view request is received from the user terminal via a communication network, the content delivery program causing a computer to execute:
storing content information containing content in a content information memory;
storing goods sales history information indicating a sales history of goods in a goods sales history information memory;
creating goods related information using the goods sales history information stored in the goods sales history information memory in the case where a content view request specifying the content is received, the goods related information relating to the goods that appear in the specified content, the goods sales history information indicating sales history of the goods;
creating content view information, the content view information containing the goods related information created in the creating the goods related information and the content specified by the content view request; and
transmitting the content view information created in the creating the content view information to the user terminal that carries out the content view request.
